(19) United States
(12) Patent Application Publication
(10) Pub. No.: US 2012/0203623 A1
(43) Pub. Date: Aug. 9, 2012

(54) SYSTEM AND METHOD FOR ONLINE ADVERTISEMENT OPTIMIZATION

(75) Inventors: NIKHIL SETHI, New York, NY (US); Garrett Ullom, New York, NY (US)

(73) Assignee: ADAPTLY, INC., New York, NY (US)

(21) Appl. No.: 13/022,299

(22) Filed: Feb. 7, 2011

(51) Int. Cl. G06Q 30/00

(52) U.S. Cl. 705/14.43

(57) ABSTRACT

A computer system and computer-implemented method for placing an advertisement on one or more social networks wherein advertisements are generated and deployed on one or more social network advertising platforms and based on performance data, adapting the parameters of the advertisement or placement of the advertisement until the performance criteria of the advertiser are met.

### BACKGROUND OF THE INVENTION

This invention relates to the field of online advertising optimization.

In recent years the art of creating and placing advertisements on internet web sites such as Yahoo, Bing, Google, and the like has become very sophisticated. Generally the advertiser pays the host web site a fee based on one or more measures such as number of times the advertisement is “clicked” on by users, the number of times the advertisement is displayed to a user, and/or the number of times a user purchases a product or service after clicking on an advertisement. The advertiser provides the content of the advertisement to the host. In the case of search engines, the advertiser can provide one or more key words to the host which, when found in search results, will cause the advertisement to be displayed to a searching user. For example, a seller of drugstore items may select toothbrush, floss, toothpaste, and flu as some of its keywords.

Many advertisers will place a single advertisement on several different hosts such as Google, Yahoo, Bing, as well as social networks such as Facebook, Linkedin, Myspace, and others, and will use various methods to allocate their spending based on varying results. A “social” network is described as a web property that collects first party information that is volunteered by users and can be used to target advertisements against them on a first party level. Also these networks describe and have created ad platforms which utilize custom elements unique to each web property to better increase the experience and utility of the web platforms themselves into the ad units that are being distributed on each social ad platform. Examples of this include: Facebook ad units with “like” buttons, Twitter ad units with promoted tweets. Such ad units are not standard IAB approved ad units.

Systems and methods for bidding for ad placement on publisher web sites such as Google and Yahoo are well known. Pisaris-Henderson, et al., US 2003/0220866 A1, for example, describe a bid amount chargeable to a participating advertiser upon response to at least one biddable advertisement determined by open auction conducted by the service provider or publisher. As responses by users to the biddable by the service provider or publisher. As responses by users to the biddable advertisement are received by the service provider, they are provided to the associated participating advertiser and that participating advertiser is charged the bid amount for the response. The advertiser associated with a biddable ad can change in real time based on the auction and associated mechanisms used by the service provider/publisher, such as a bid weighted rotation which associates the biddable ad to a number of participating advertisers.

Systems for ranking the quality of internet traffic from one web site to another have been published. For example, Fishteyn, et al., U.S. 2004/0190448 A1 disclosed a system and method of determining a quality ranking of user traffic directed from at least one traffic producer Web site to a traffic consumer Web site. A reference for the traffic consumer is established on a Web site of the traffic producer. The reference includes a link from the traffic producer to a traffic quality intermediary and a unique identifier to identify the traffic consumer. The traffic quality intermediary receives user traffic data associated with the user traffic directed from the traffic producer and determines a quality ranking of the user traffic based upon the user traffic data.

For example, Schwarz, et al., US 2010/0293047 A1 disclosed an ad network system for optimizing the purchase of online display advertisement inventory which includes an advertiser management system to manage and acquire data for a set of advertising campaigns for a set of advertisers and a publisher management system to manage and acquire data for inventory at publishers' sites and applications. A media buying system runs a two-part optimization to determine an allocation of available inventory and an inventory purchase plan is based on the data acquired by the advertiser management system and publisher management system.

Flake, et al., US 2008/0103953 A1 disclosed a tool for optimizing advertising across disparate online advertising networks wherein a participant can specify goals and/or constraints for participating and the tool can automatically optimize advertising expenditures for advertising transactions across the different networks while also tracking the performance of the participant across the different networks and dynamically tunes the participant's advertising expenditure based on such performance as well as the changing conditions of the marketplace.

Another online advertising optimization system was disclosed by Torigoe, et al., US 2010/0250361 A1, wherein features of the advertisement are defined and a predicted click through rate (CTR) corresponding to the advertisement based in part on the set of feature is generated and the advertisement is ranked and served based on the ranking.

More recently social network advertising has become a greater percentage of online advertising than previously. Examples of social networks which have only recently begun displaying advertisements are Facebook.com, Linkedin,com, Twitter.com, Ning.com, myspace.com, reddit.com, StumbleUpon,com. Social network advertising differs from search engine site advertising in that much more data about particular users is available to advertisers and advertising agencies and aggregators than with search engine sites, newspaper sites, and the like. However, to date there has been much room for improvement in the art of customizing advertisements and placing them on the various social networks, measuring results and effectiveness, and dynamically improving the advertisements to increase their effectiveness, while carrying out the advertisers' objectives within the advertisers' budgets.

It is an object of this invention to provide an improved method and system for such customizing advertisements and placing them on the various social networks, measuring results and effectiveness, and dynamically improving the advertisements to increase their effectiveness, while carrying out the advertisers' objectives within the advertisers' budgets.

### SUMMARY OF THE INVENTION

These objects and others which will become apparent from the following disclosure are achieved by the present invention which comprises in one aspect computer system comprising, a processor, a computer readable medium in communication with the processor, the computer readable medium having encoded thereon a set of instructions executable by the computer system to perform one or more operations, the set of instructions comprising instructions for
a) receiving an order from an advertiser client to place an advertisement on one or more social networks;
b) receiving one or more advertisement performance criteria for the advertisement from the advertiser client;
c) receiving data regarding a product or service to be described in the advertisement;
d) outputting an advertisement for the product or service having a first set of format parameters;
e) deploying the advertisement for the product or service having a first set of format parameters on at least one social network advertising platform;
f) receiving performance data for the advertisement for the product or service having a first set of format parameters;
g) calculating whether the performance data meets the advertisement performance criteria for the advertisement received from the advertiser client;
h) outputting the advertisement with a second set of format parameters;
i) deploying the advertisement with the second set of format parameters on at least one social network;
j) repeating steps g), h), and i) until the performance data at least meets the advertisement performance criteria for the advertisement received from the advertiser client; and
k) reporting the performance of the advertisement to the advertising client.

In another aspect, the invention comprises a computer method comprising
a) receiving with a computer an order from an advertiser client to place an advertisement on one or more social networks;
b) receiving with the computer one or more advertisement performance criteria for the advertisement from the advertiser client;
c) receiving with the computer data regarding a product or service to be described in the advertisement;
d) outputting with the computer an advertisement for the product or service having a first set of format parameters;
e) deploying with the computer the advertisement for the product or service having a first set of format parameters on at least one social network advertising platform;
f) receiving with the computer performance data for the advertisement for the product or service having a first set of format parameters;
g) calculating with the computer whether the performance data meets the advertisement performance criteria for the advertisement received from the advertiser client;
h) outputting with the computer the advertisement with a second set of format parameters;
i) deploying with the computer the advertisement with the second set of format parameters on at least one social network;
j) repeating with the computer steps g), h), and i) until the performance data at least meets the advertisement performance criteria for the advertisement received from the advertiser client; and
k) reporting with the computer the performance of the advertisement to the advertising client.

In some embodiments the one or more social networks have format requirements and the system is programmed to change the format parameters of the advertisement to meet the format requirements of the one or more social networks on which the advertisement is to be deployed. In certain cases the one or more social networks receive advertisements for Web, mobile, video, audio, or offline channels. Optionally the system can be programmed so that the one or more social networks on which the advertisement is to be deployed can be selected either by the advertiser client or by the system. Also, the system can output the advertisement with second and subsequent sets of format parameters selected from size, scale, placement cost, URL requirements, title length, and body length, the sets of format parameters calculated to improve the performance of the advertisement on one or more selected social advertisement platforms.

Preferably, the system is programmed to deploy and redeploy the advertisement on one or more networks based on network performance. In certain preferred embodiments the system and related method receive and calculate volume and relevancy of conversation data from social platforms to output parameters of an advertisement and on which social network where the advertisement will have the highest probability of meeting the performance criteria received from the advertising client. In some embodiments of the invention weight is assigned to conversation data from a social network and format parameters, number of advertisement placements on the social network, or advertising spend on the social network is determined by the system based in part on said assigned weight. A metric value can be calculated according to a formula which considers one or more factors selected from clicks, click through rate (CTR), impressions, average cost per click (avg. CPC), cost, and conversions values and advertisements are ordered on one or more social networks which yield the highest metric, depending on the embodiment. In certain preferred embodiments the system can be programmed to dynamically and periodically assign weights to title, image, body, targeting, geographical, and demo data, deploy a set of advertisements on one or more social networks which have varying weights, and removing advertisements within the deployed set which do not meet performance criteria.

The computer system can be programmed to output the advertisement with second and subsequent sets of format parameters selected from filter, border, color, overlay, red-blue-green balance (RBG), and edge. The system can also be programmed to calculate trends and number of occurrences of a brand on a social network and output a viral value for the social network, and deploy the advertisement on a social network having the highest viral value.

According to some embodiments, the system will scan a social network for conversation and dialogue data relating to the product or service, assign a weight to each conversational element, and to deploy an advertisement on a social network if the assigned weight exceeds a threshold value. In more advanced embodiments the system will receive real time event data, dynamically modify an advertisement upon receipt of the real time event data, wherein the resultant modified advertisement includes a reference to a real time event within the received real time event data.

An order from an advertising client can comprise a spending budget and advertisements are deployed on one or more social network so that the cost of deployment does not exceed the budget according to an algorithm which calculates an index for price based on chosen segments based on monitoring average prices for each individual metric over time. The method executed on the system of the invention will, in most cases, deploy advertisements on one or more social networks so that the cost of deployment does not exceed a predetermined cost limit or budget.

### BRIEF DESCRIPTION OF THE DRAWINGS

Certain embodiments of the invention are illustrated by way of figures in the accompanying drawings in which:

FIG. 1 is a flow chart of a generalized process of one embodiment of the invention.

FIG. 2 is a flow chart of an aspect of certain embodiments wherein the system automatically deploys ad content on social networks.

FIG. 3 is a flow chart of an aspect of certain embodiments wherein the system returns performance data.

FIG. 4 is a flow chart of an aspect of certain embodiments wherein ads deploy across different self-serve ad platforms.

FIG. 5 is a flow chart of an aspect of certain embodiments wherein the system assigns values or weights to different social networks for performance.

FIG. 6 is a flow chart of an aspect of certain embodiments wherein the system tracks performance and weight for each ad campaign.

FIG. 7 is a flow chart of an aspect of certain embodiments wherein the system automatically reallocates spend and/or ad units based on network performance.

FIG. 8 is a flow chart of an aspect of certain embodiments wherein one ad template is used to generate multiple ad unit variations repetitively.

FIG. 9 is a flow chart of an aspect of certain embodiments wherein one ad template is used to generate multiple ad unit variations repetitively and the ads are genetically evolved.

FIG. 10 is a flow chart of an aspect of certain embodiments wherein the social networks are monitored for trends and trend (“viral”) data are used as coefficients causing the ad to be placed on a social network with the highest viral coefficient.

FIG. 11 is a flow chart of an aspect of certain embodiments wherein the social networks (“webs”) are monitored for trending items and ads are placed based on viral coefficients.

FIG. 12 is a flow chart of an aspect of certain embodiments wherein ads are purchased based on budgets rather than bids and the system returns all data to advertiser.

The invention is not limited to the illustrated embodiments.

### DETAILED DESCRIPTION

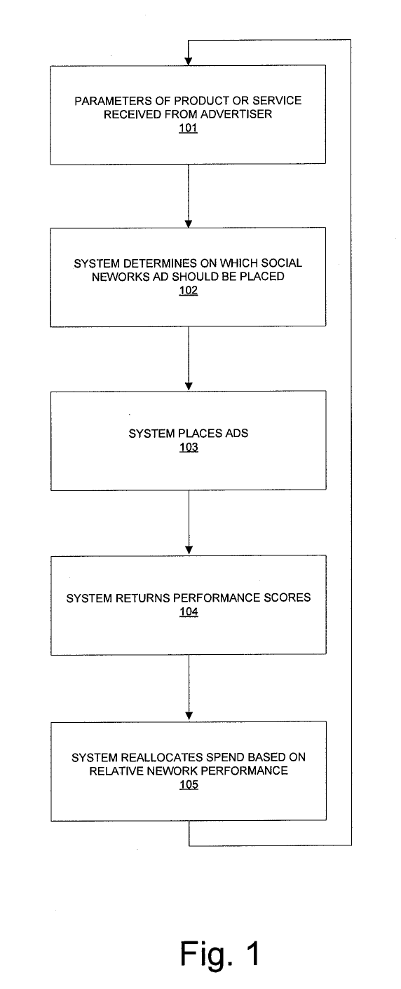

Referring now to the drawings wherein certain embodiments of the invention are illustrated in flow charts, FIG. 1 illustrates the general framework of a system starting with step 101 wherein an advertiser submits a product or service to advertise. Using the programmed computer of the invention, the system receives an order from an advertiser 101 and determines 102 which social networks the ad should be placed on, places the ads 103, returns performance data 104, and reallocates 105 the advertising spend based on which network performed the best in terms of the criteria set by the advertiser client. The system uses a set of variables to determine and optimize performance of an ad based on parameters and targeting available from social network platforms.

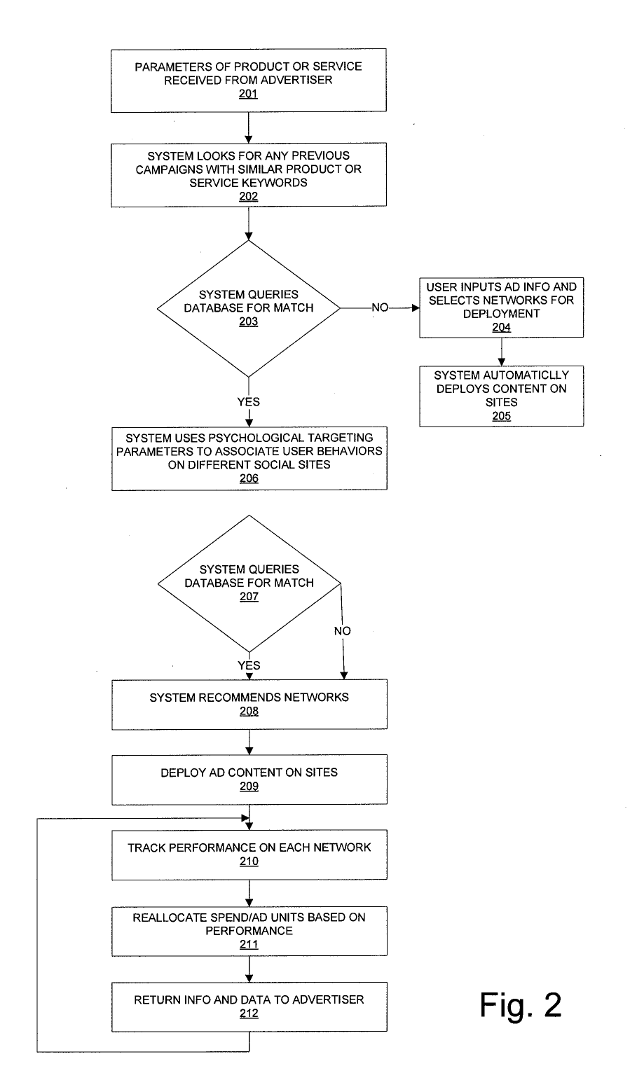

FIG. 2 illustrates a process flow chart wherein an the system receives 201 parameters submitted by an advertiser client and looks 202 for any previous campaigns with similar product or service keywords, then queries 203 a database for a match. If there is no match, the user inputs 204 ad information and selects network for deployment. The system automatically deploys 205 the ad content on sites. If there is a match in the database, the system uses psychological targeting parameters to associate 206 user behaviors on different social sites. The database is again queried 207 for a match and depending on whether or not there was a match, the system recommends 208 which network(s) the advertiser should chose. Upon confirmation or revision by advertiser client, the system automatically deploys 209 the ad on social network sites. The system, according to the invention, tracks 210 performance on each network, reallocates 211 spend/ad units based on network performance, and reports 212 information and data to the advertiser.

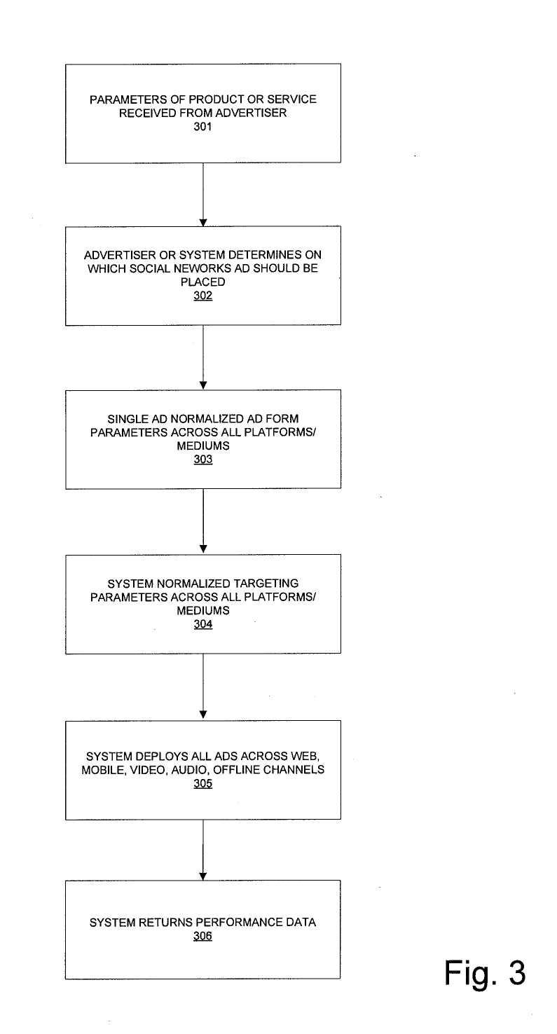

As shown in FIG. 3, the system can take a designated ad from advertiser and place that ad on a collection of fragmented self-serve ad platforms. These platforms can include but are not limited to Facebook, Myspace, linkedin, reddit, and plenty of fish, among the currently popular social networks, with other networks expected to become popular and useful in the future. The system can deploy the same piece of ad unit across multiple mediums (web, mobile, video, audio, offline). The system can return data and performance from all channels and all mediums back to advertiser. In step 301 an ad is received from an advertiser and then the advertiser or the system can chose 302 which self-serve social networks the ad will be deployed on, and then normalize 303 the ad form parameters across all platforms and mediums, and normalize 304 the targeting parameters across all platforms and mediums. The system then deploys 305 the ad across web, mobile, video, audio, and offline channels and finally returns 306 performance scores to the advertiser.

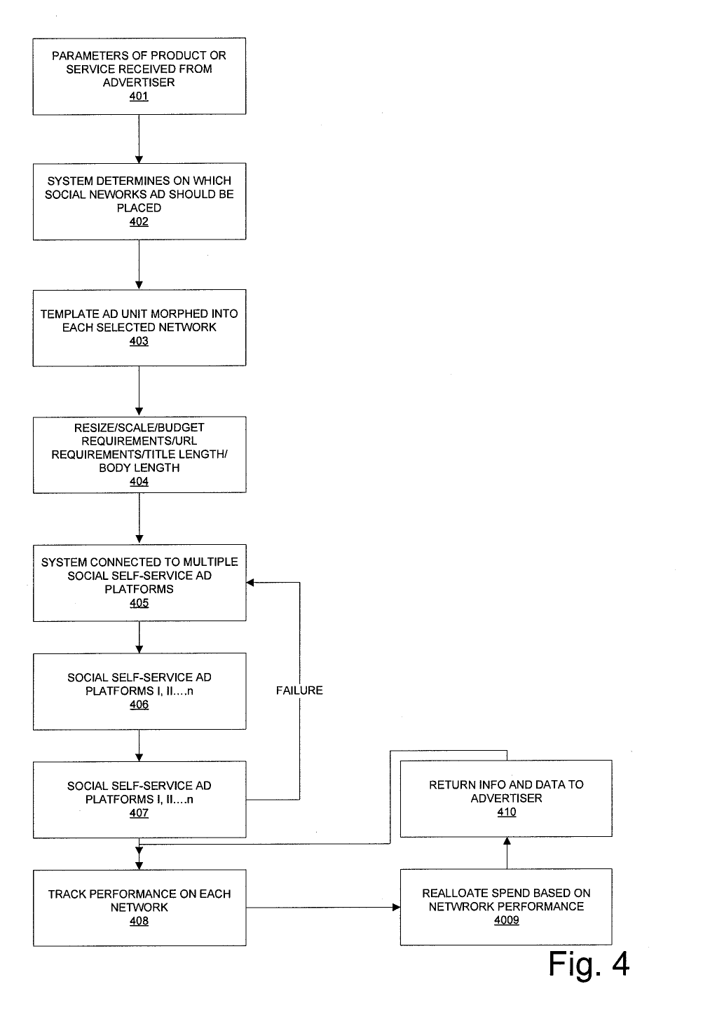

FIG. 4 illustrates an embodiment wherein ads are deployed across different self-serve social networks starting with receipt 401 of parameters of a product or service to advertise and selection 402 of networks for deployment. The system then takes a template ad unit and morphs 403 it into each selected network by changing 404 the advertisement using an algorithm which modifies an ad in view of size, scale, budget requirements, URL requirements, title length, and body length, and connects 405 to multiple social ad platforms 406, reports 407 success or failure. If success 407, the system continuously and repetitively tracks 408 performance on each network, reallocates 409 spend/ad units based on network performance, returns 410 all information and data through an analytics platform to the advertiser client. If failure 408, the process repeats by connecting 405 to multiple ad platforms.

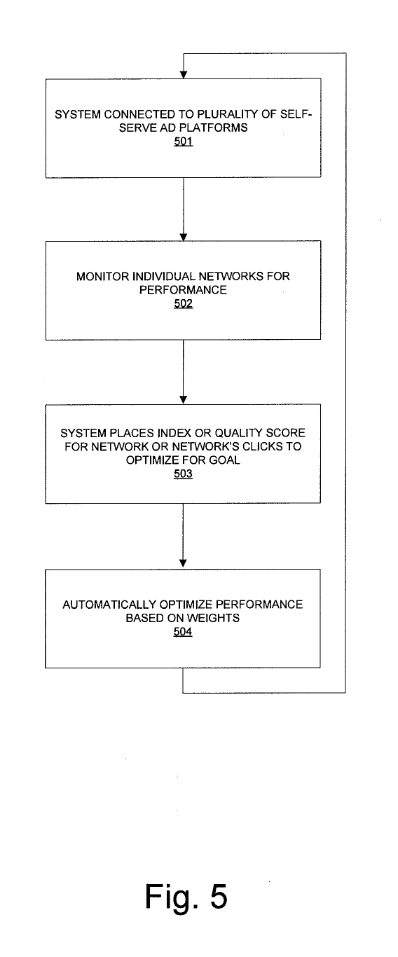

FIG. 5 illustrates the weighing performance of a given ad platform or given click from a given ad network and using the information to better target and optimize an advertiser's ad unit across multiple self-serve ad platforms wherein the system connects 501 to many self-serve ad platforms and monitors502 individual networks for performance, then places 503 an index or quality score for network or for network's clicks to optimize for goal. The system automatically, continuously, and repetitively optimizes 504 performance against quality of clicks based on weights.

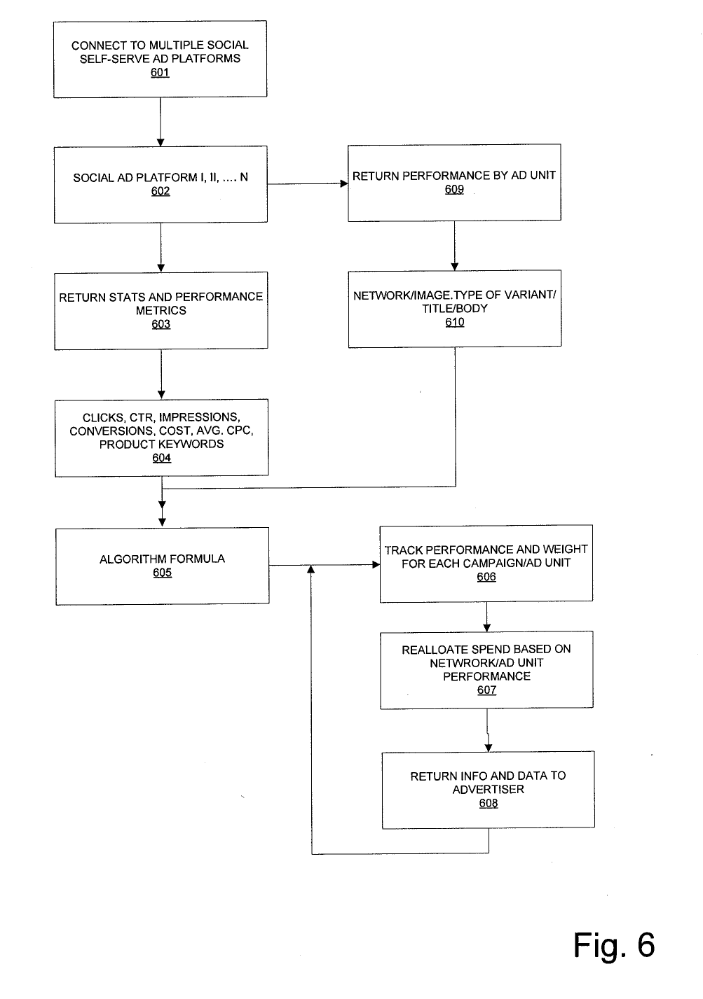

Referring now to FIG. 6, the system again is connected 601 to multiple social self-serve ad platforms 602 which return 603 statistics and performance metrics, including in this embodiment clicks, click through rate (CTR), impressions, conversions, cost, average cost per click (CPC), and product keywords and type 604. The platforms also return 609 performance by ad unit in terms of network, image, title/body, and type of variant 610 which, along with the statistics and performance metrics 604 are processed 605 by the system according to an algorithm and the system tracks 606 performance and weight for each campaign, reallocates 607 spend/ad units based on network performance and returns 608 resultant data and information through the analytics platform to the advertiser client.

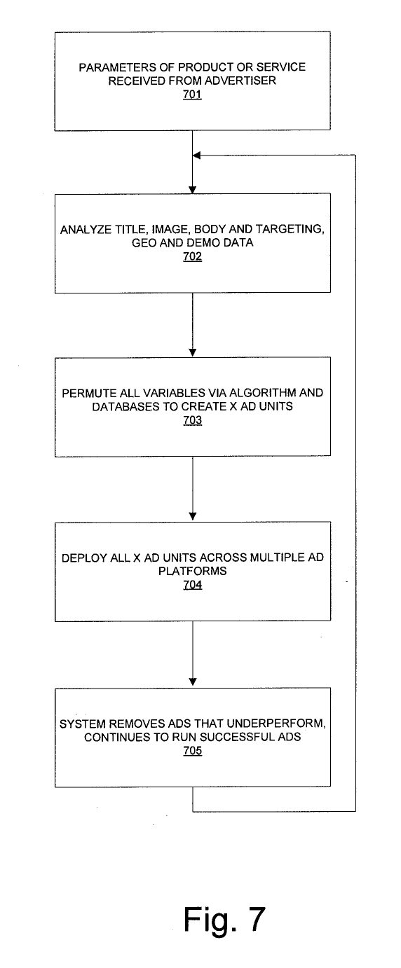

In the embodiment shown in FIG. 7, the system is configured to take an inputted ad unit consisting of an image, title, and body and permute on those three inputs to generate any number of additional similar ad units. The system can then take all generated ad units and deploy them across multiple self-serve ad networks to determine which ad units were the most successful, upon which the system will remove underperforming ads and continue to optimize ads that are successful. Starting with step 701, the advertiser submits to the system a product/service to advertise and the system analyzes 702 three variables, title, image, and body, and targeting, geo, and demo data. The system permutes 703 all the variables using algorithms and databases and deploys 704 the resultant ad units across multiple platforms, removing 705 ads which underperform and continuing to run successful ads, which repetitively analyzing the variables 702.

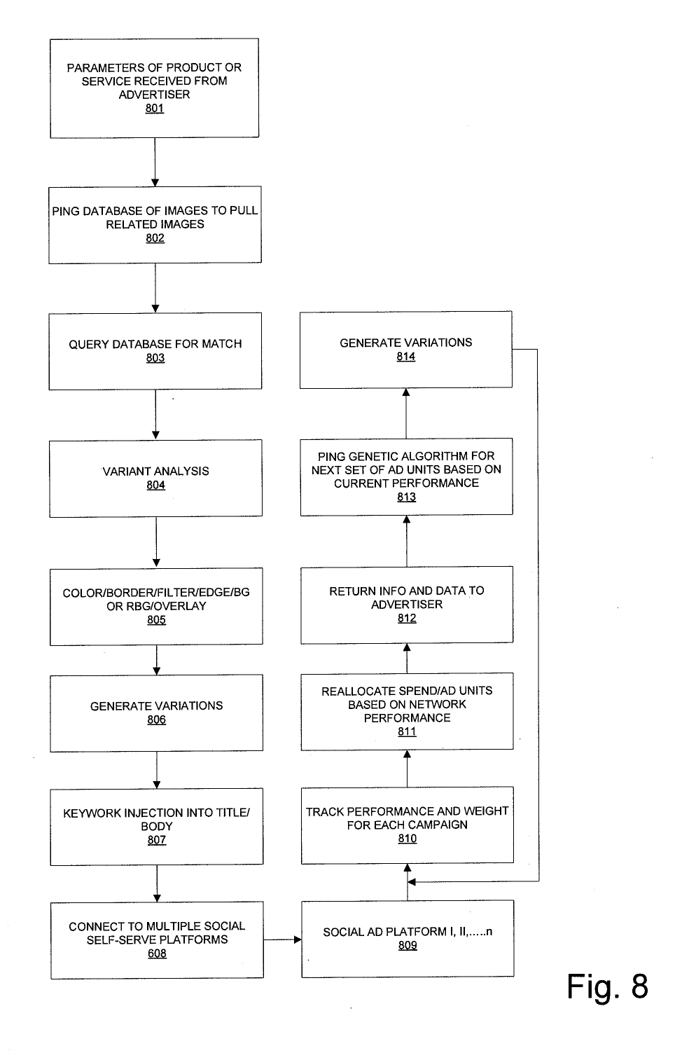

In FIG. 8, a process is shown wherein one ad template is used to generate multiple ad unit variations in a circuit fashion in a manner analogous to genetic evolution. Starting again with receipt 801 from an advertiser of a template ad with image, title, body, and keywords, the system looks up 802 in an approved database related images and queries 803 the database for a match. A variant analysis is then performed 804 where the variables are color, border, filter, edge, blue-green or blue green red balance, and overlay, which is used to generate 806 variations and inject 807 keywords into the title and or body. The system is connected 808 to multiple social self-serve ad platforms 809 and tracks 810 performance and weight for each campaign, reallocating 811 spend per ad units based on network performance, returning 812 information and data through an analytics platform to the advertiser client. The system can ping 813 a genetic algorithm for the next set of ad units based on current performance and generate 814 variations of the ad, while continuously tracking 810 performance and weight, etc. (811-813).

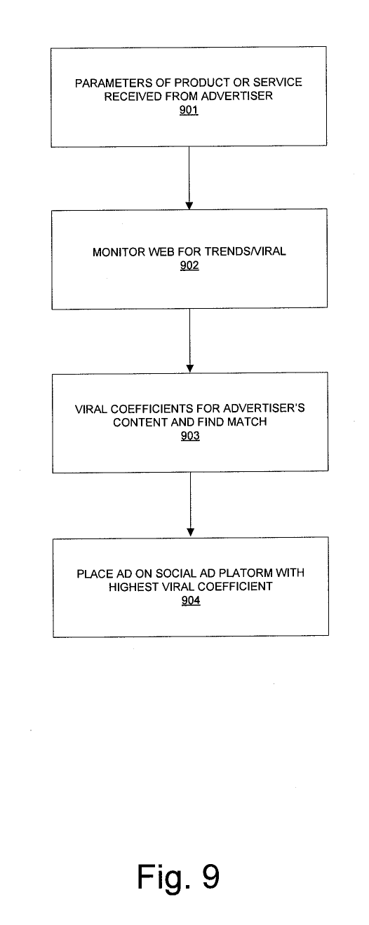

Referring to FIG. 9 illustrates an embodiment wherein campaign and associated data is received from an advertiser and social networks are monitored 902 for trends, referred to in the art as “going viral,” wherein the system takes viral coefficients for the advertiser's content and finds 903 a match which is automatically 904 placed on the social network with the highest viral coefficient. In this process the system receives data and processes it to determine how many users of a social network are talking about a brand, for example.

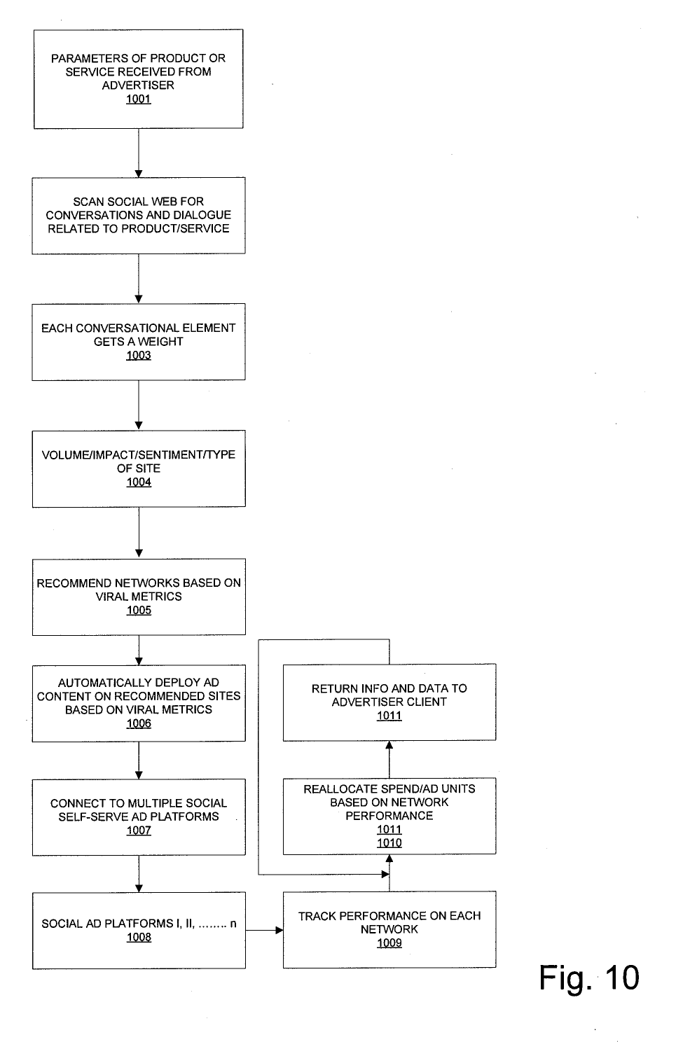

The viral coefficient calculated in the process shown in FIG. 9 is illustrated in more detail in FIG. 10 wherein after the advertiser's parameters of product or services is received 1001, the web is scanned 1002 for conversations and dialogue related to the product or service. For example, if may users of Facebook are entering comments or likes about a Chevy Volt, the conversational elements are assigned 1003 a weight in terms of volume, impact, sentiment, and type of site, for example 1004, the data is processed and the system recommends 1005 which networks the advertiser should use based on the viral metrics. The system can automatically deploy 1006 ad content on recommended sites based on viral metrics. Since the system is connected 1007 to multiple social self service ad platforms 1008, the system can track 1009 performance on each network, reallocate 1010 spending per ad units based on network performance and return all the information and data through the analytics platform to the advertiser.

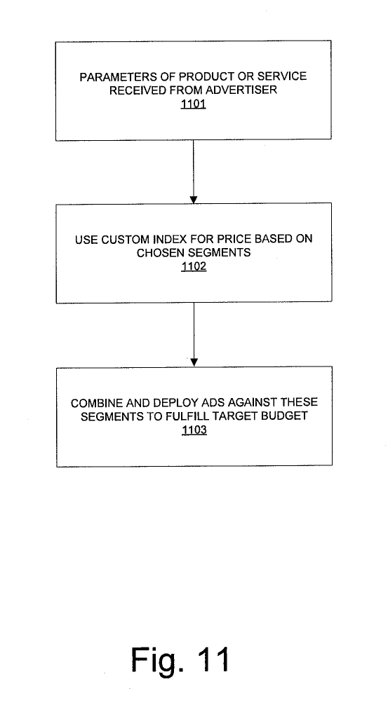

In the embodiment illustrated in FIG. 11, the system receives 1101 campaign and associated data from the advertiser, uses 1102 a custom index for price based on chosen segments, and combines 1103 and deploys ads against these segments to fulfill target budget instead of bidding. In this way the system does not use bids to purchase ads but uses correlated prices of certain demographic and targeting segments valued by network to charge advertiser clients for ad buys on social properties.

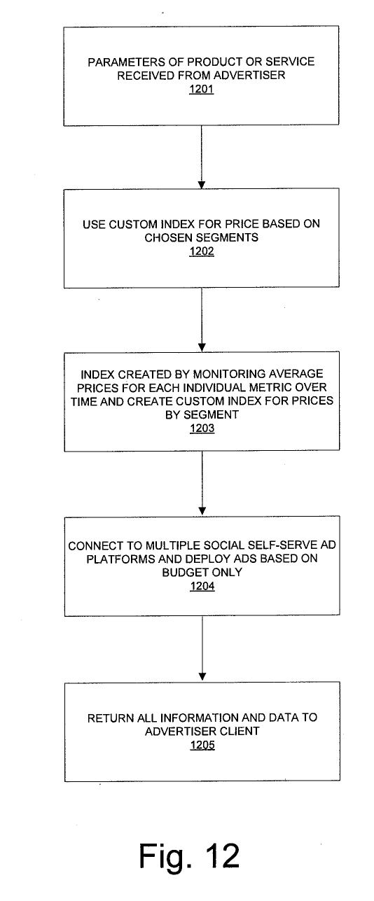

FIG. 12 illustrates an embodiment wherein the system receives 1201 campaign and associated data from the advertiser, uses 1202 a custom index for price based on chosen segments, the custom index created 1203 by monitoring average prices for each individual metric over time and creating the index for these prices by segment. The system, as noted earlier, is connected 1204 to multiple social self-serve ad platforms and deploys ads based on budgets rather than on bids, finally returning 1205 all information and data through the analytics platform to the advertiser. In this way the system does not use bids to purchase ads but uses correlated prices of certain demographic and targeting segments valued by network to charge advertiser clients for ad buys on social properties.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. A computer system comprising, a processor, a computer readable medium in communication with the processor, the computer readable medium having encoded thereon a set of instructions executable by the computer system to perform one or more operations, the set of instructions comprising instructions for
a) receiving an order from an advertiser client to place an advertisement on one or more social networks;
b) receiving one or more advertisement performance criteria for the advertisement from the advertiser client;
c) receiving data regarding a product or service to be described in the advertisement;
d) outputting an advertisement for the product or service having a first set of format parameters;
e) deploying the advertisement for the product or service having a first set of format parameters on at least one social network advertising platform;
f) receiving performance data for the advertisement for the product or service having a first set of format parameters;
g) calculating whether the performance data meets the advertisement performance criteria for the advertisement received from the advertiser client;
h) outputting the advertisement with a second set of format parameters;
i) deploying the advertisement with the second set of format parameters on at least one social network;
j) repeating steps g), h), and i) until the performance data at least meets the advertisement performance criteria for the advertisement received from the advertiser client; and
k) reporting the performance of the advertisement to the advertising client.

2. The system of claim 1 wherein the one or more social networks have format requirements and the system is programmed to change the format parameters of the advertisement to meet the format requirements of the one or more social networks on which the advertisement is to be deployed.

3. The system of claim 1 wherein the one or more social networks receive advertisements for Web, mobile, video, audio, or offline channels.

4. The system of claim 1 programmed so that the one or more social networks on which the advertisement is to be deployed can be selected either by the advertiser client or by the system.

5. The system of claim 1 programmed to output the advertisement with second and subsequent sets of format parameters selected from size, scale, placement cost, URL requirements, title length, and body length, the sets of format parameters calculated to improve the performance of the advertisement on one or more selected social advertisement platforms.

6. The system of claim 1 programmed to deploy and redeploy the advertisement on one or more networks based on network performance.

7. The system of claim 1 programmed receive and calculate volume and relevancy of conversation data from social platforms to output parameters of an advertisement and on which social network where the advertisement will have the highest probability of meeting the performance criteria received from the advertising client.

8. The system of claim 1 wherein weight is assigned to conversation data from a social network and format parameters, number of advertisement placements on the social network, or advertising spend on the social network is determined by the system based in part on said assigned weight.

9. The system of claim 1 wherein a metric value is calculated according to a formula which considers one or more factors selected from clicks, click through rate (CTR), impressions, average cost per click (avg. CPC), cost, and conversions values.

10. The system of claim 1 wherein a metric value is calculated according to a formula which considers one or more factors selected from clicks, click through rate (CTR), impressions, average cost per click (avg. CPC), cost, and conversions values and advertisements are ordered on one or more social networks which yield the highest metric.

11. The system of claim 1 programmed to dynamically and periodically assign weights to title, image, body, targeting, geographical, and demo data, deploy a set of advertisements on one or more social networks which have varying weights, and removing advertisements within the deployed set which do not meet performance criteria.

12. The system of claim 1 programmed to output the advertisement with second and subsequent sets of format parameters selected from filter, border, color, overlay, red-blue-green balance (RBG), and edge.

13. The system of claim 1 programmed to calculate trends and number of occurrences of a brand on a social network and output a viral value for the social network, and deploy the advertisement on a social network having the highest viral value.

14. The system of claim 1 programmed to scan a social network for conversation and dialogue data relating to the product or service, assign a weight to each conversational element, and to deploy an advertisement on a social network if the assigned weight exceeds a threshold value.

15. The system of claim 1 programmed to receive real time event data, dynamically modify an advertisement upon receipt of the real time event data, wherein the resultant modified advertisement includes a reference to a real time event within the received real time event data.

16. The system of claim 1 wherein the order from the advertising client comprises a spending budget and advertisements are deployed on one or more social network so that the cost of deployment does not exceed the budget according to an algorithm which calculates an index for price based on chosen segments based on monitoring average prices for each individual metric over time.

17. A computer method comprising
a) receiving with a computer an order from an advertiser client to place an advertisement on one or more social networks;
b) receiving with the computer one or more advertisement performance criteria for the advertisement from the advertiser client;
c) receiving with the computer data regarding a product or service to be described in the advertisement;
d) outputting with the computer an advertisement for the product or service having a first set of format parameters;
e) deploying with the computer the advertisement for the product or service having a first set of format parameters on at least one social network advertising platform;
f) receiving with the computer performance data for the advertisement for the product or service having a first set of format parameters;
g) calculating with the computer whether the performance data meets the advertisement performance criteria for the advertisement received from the advertiser client;
h) outputting with the computer the advertisement with a second set of format parameters;
i) deploying with the computer the advertisement with the second set of format parameters on at least one social network;
j) repeating with the computer steps g), h), and i) until the performance data at least meets the advertisement performance criteria for the advertisement received from the advertiser client; and
k) reporting with the computer the performance of the advertisement to the advertising client.

18. The method of claim 16 comprising changing with the computer the format parameters of the advertisement to meet the format requirements of the one or more social networks on which the advertisement is to be deployed.

19. The method of claim 16 placing with the computer on one or more social networks advertisements for Web, mobile, video, audio, or offline channels.

20. The method of claim 16 comprising selecting manually by the advertiser or automatically with the computer one or more social networks on which the advertisement is to be deployed.

21. The method of claim 16 comprising generating with the computer the advertisement with second and subsequent sets of format parameters selected from size, scale, placement cost, URL requirements, title length, and body length, the sets of format parameters calculated to improve the performance of the advertisement on one or more selected social advertisement platforms.

22. The method of claim 16 comprising deploying and redeploying with the computer the advertisement on one or more networks based on network performance.

23. The method of claim 16 comprising receiving and calculating with the computer volume and relevancy of conversation data from social platforms to output parameters of an advertisement and on which social network where the advertisement will have the highest probability of meeting the performance criteria received from the advertising client.

24. The method of claim 16 comprising assigning with the computer weight to conversation data from a social network and format parameters, number of advertisement placements on the social network, or advertising spend on the social network is determined by the system based in part on said assigned weight.

25. The method of claim 16 comprising calculating with the computer a metric value according to a formula which considers one or more factors selected from clicks, click through rate (CTR), impressions, average cost per click (avg. CPC), cost, and conversions values.

26. The method of claim 16 comprising calculating with the computer a metric value according to a formula which considers one or more factors selected from clicks, click through rate (CTR), impressions, average cost per click (avg. CPC), cost, and conversions values and advertisements are ordered on one or more social networks which yield the highest metric.

27. The method of claim 16 comprising dynamically and periodically assigning weights with the computer to title, image, body, targeting, geographical, and demo data, deploy a set of advertisements on one or more social networks which have varying weights, and removing advertisements within the deployed set which do not meet performance criteria.

28. The method of claim 16 comprising outputting the advertisement with the computer second and subsequent sets of format parameters selected from filter, border, color, overlay, blue-green balance (BG), and edge.

29. The method of claim 16 comprising calculating with the computer trends and number of occurrences of a brand on a social network and output a viral value for the social network, and deploy the advertisement on a social network having the highest viral value.

30. The method of claim 16 comprising scanning with the computer a social network for conversation and dialogue data relating to the product or service, assign a weight to each conversational element, and to deploy an advertisement on a social network if the assigned weight exceeds a threshold value.

31. The method of claim 16 comprising calculating with the computer an index for price based on chosen segments based on monitoring average prices for each individual metric over time.

32. The method of claim 16 comprising deploying with the computer advertisements on one or more social network so that the cost of deployment does not exceed a predetermined cost limit.
